(19) United States
(12) Patent Application Publication
(10) Pub. No.: US 2014/0306369 A1
(43) Pub. Date: Oct. 16, 2014

(54) BENEFICIATION OF FLY ASH

(71) Applicant: RockTron Mineral Services Limited, Chepstow (GB)

(72) Inventors: Nigel Peter Smalley, Chepstow (GB); Paul Anthony Shepheard, Chepstow (GB); Philip Michael, Chepstow (GB)

(21) Appl. No.: 14/352,552

(22) PCT Filed: Oct. 19, 2012
(86) PCT No.: PCT/GB2012/000805

§ 371 Date: Apr. 17, 2014

(30) Foreign Application Priority Data
Oct. 20, 2011 (GB) 1118077.5

(51) Int. Cl. C08K 3/36; C08K 3/22; B29C 47/00

(52) U.S. Cl. CPC C08K 3/36; B29C 47/0004; B29C 47/0066; C08K 3/22; C08K 2003/2227
USPC 264/142; 428/402; 264/176.1; 106/405

(57) ABSTRACT

A method of beneficiating fly ash to produce particulate material for use as a filler/extender in plastics manufacturing. The method includes removal of extraneous surface deposits from surfaces of the particulate material.

This invention relates to the beneficiation of fly ash and the use of particulate material resulting therefrom as a filler-extender in plastics manufacturing, particularly but not necessarily exclusively the extrusion of synthetic plastics materials.

In relation to the present invention, fly ash is a residue from combustion of coal in a power station, comprising fine particles that rise with the flue gases (in contrast with bottom ash). To prevent its environmentally damaging release to the atmosphere, fly ash is captured at the power station, typically by electrostatic separators. It may be held at the power station, in a tip or a lagoon, or it may be disposed of by landfill.

Worldwide, power stations create hundreds of millions of tonnes of fly ash each year. Some is used as a pozzolan in the manufacture of cement and concrete, but it is widely regarded as waste.

Beneficiation is a process whereby useful products are recovered from fly ash. More precisely, beneficiation is a bundle of processes such as separation, extraction, washing and classifying applied to the fly ash to yield different minerals with various uses. As well as pozzolan, minerals previously obtained by beneficiation include: cenospheres, which are hollow alumino-silicate spheres, used in the manufacture of low-density concrete and syntactic foams; carbon, in the form of unburnt coal or char, which may be returned for burning in the power station or used to make value-added products such as activated carbon and magnetite spheres, used in sound insulation and in the manufacture of electrically conductive compounds.

The present invention has as objects the extraction from fly ash of alumino-silicate particles which are of particular use in plastics manufacturing.

According to a first aspect of the invention there is provided a method of beneficiating fly ash to produce particulate material for use as a filler/extender in plastics manufacturing, characterised in that said method includes removal of extraneous surface deposits from surfaces of the particulate material.

International patent application WO9937592 (Hwang et al) concerns a process for producing a filler from fly ash by (as stated by Hwang) “cleaning and separating the finest fraction”. However Hwang's “cleaning” procedure is expressly concerned with removing “the carbon content, cenospheres or magnetic particles” and not at all with the removal of extraneous surface deposits from surfaces of the particulate material. In other words, Hwang's filler essentially comprises residual material remaining after carbon, cenospheres and magnetic material has been extracted from the fly ash, which residual material will necessarily carry extraneous surface deposits that will impair its use as a filler/extender in plastics manufacturing. Hwang did not perceive the benefits (secured by the present invention) of ensuring that filler material obtained by the beneficiation of fly ash is not contaminated by extraneous surface deposits.

The extraneous surface deposits removed from surfaces of the particulate fly ash material by means of the present invention are mostly surface salts (especially alkali metal compounds) that appear to be precipitated from condensates onto the particulate material (which is alumino-silicate) when formed in the furnace. We have found that these extraneous deposits cause polymer degradation when the particulate material is used as a filler/extender in plastics manufacturing. The removal of the extraneous surface deposits from surfaces of the particulate material in the present invention therefore substantially improves product quality in the plastics manufacturing.

The removal of the extraneous surface deposits may include leaching water-soluble salts from the surfaces of the particulate material or attrition scrubbing of the particulate material.

Preferably the first aspect of the invention includes de-agglomerating the particulate material. This provides improved dispersion of the particulate material when used as a filler/extender in plastics manufacturing.

The first aspect of the invention may also include selective liberation of mineral species from the particulate material. This increases recovery and improves purity of individual mineral species obtained from the fly ash.

The first aspect of the invention may include staged screening—eg by vibrating screen or moving cloth screen—of the particulate material to produce particles within defined size bands. Whilst the residual particulate material after screening and the removal of cenospheres etc may be extracted from the suspension and used directly as a filler in plastics manufacturing, it is preferable to grade it, eg by air classification, into fine and coarse particles which can then be mixed in specified proportions. Non-uniform particle size distribution, within a specified range, has an advantage for certain filler/extender applications in allowing a greater packing density. It should also be understood that the particulate material can be size-classified within the slurry and then dried, or it may be dried and then classified.

The particulate material (especially coarser fractions) may be milled.

Cenospheres may be separated from the particulate material by means of gravity separation.

Carbon may be separated from the particulate material by means of pneumatic froth flotation. In this we have found that the pneumatic froth flotation technology as described in European Patent EP 0757591 and related patents is particularly effective in obtaining commercial grade carbon, providing improved separation and therefore purer product.

Magnetic material may be separated from the particulate material.

Overall, the present invention in its first aspect may comprise a method comprising the steps of:

(a) forming a slurry of the fly ash;

(b) de-agglomerating particles in the slurry to produce a suspension;

(c) screening the suspension to remove therefrom particles above a specified size; and

(d) removing cenospheres, carbon and magnetic material from the suspension.

According to a second aspect of the invention there is provided a filler/extender for use in plastics manufacturing, which filter comprises particulate material produced by the beneficiation of fly ash according to the first aspect of the invention characterised in said particulate material comprises alumina-silicate particles of rounded form.

The particles may comprise 48-60% SiO₂ and 20-30% AL₂O₃, they are preferably of non-uniform particle size, and they may have a specific gravity in the range 2.2 to 2.3.

In a third aspect of the invention the filler/extender of the second aspect may be used in a compound comprising a resin (eg polypropylene, polyethylene, polyvinyl chloride or polybutylene terephthalate) and up to 60% of the filler/extender.

The particles of the filler/extender are preferably nodular and they may have the characteristics set out in Table 1 or Table 2 herein.

We have found that the filler/extender of the invention is of particular use in compounds with polypropylene resin for extrusion, and thus the invention extends in a fourth aspect to a method of making articles by plastics extrusion comprising heating a compound of the filler/extender with polypropylene resin to soften it and extruding the softened compound through a die.

A fifth aspect of the invention comprises making articles by plastics extrusion characterised in that said articles are pellets of said compound formed by pelletising the compound extruded through the die.

The invention will now be described by way of example only with reference to the accompanying drawings, which are purely schematic and not to scale and in which

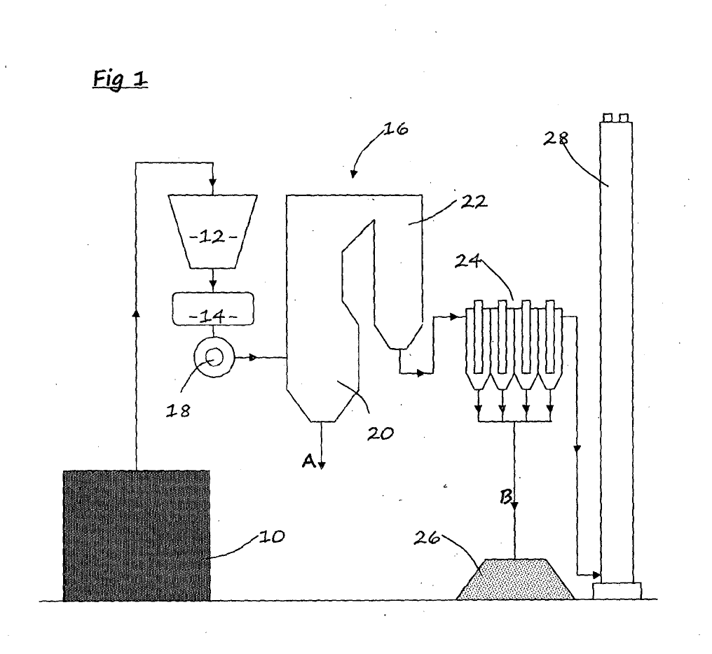

FIG. 1 illustrates a typical coal-fired power station creating fly ash;

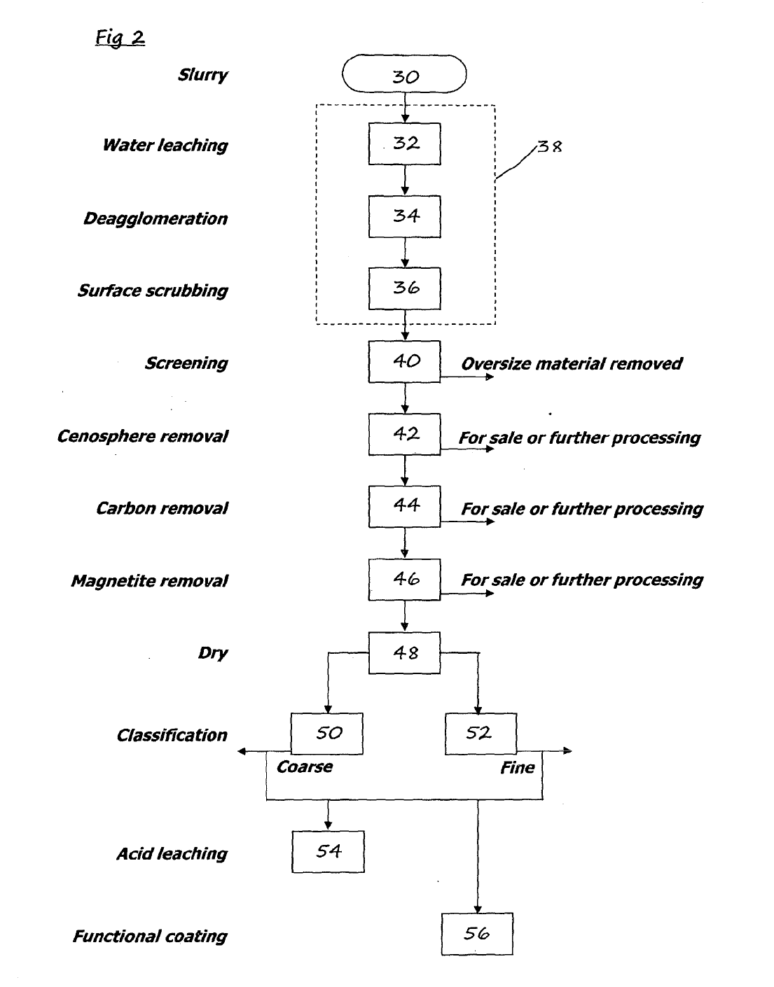

FIG. 2 is a flow chart illustrating the beneficiation of fly ash from the power station of FIG. 1, according to the invention, of use in relation to plastics manufacturing;

FIG. 3 is a table (Table 1) setting out the characteristics of a first particulate material formed by the method of FIG. 3;

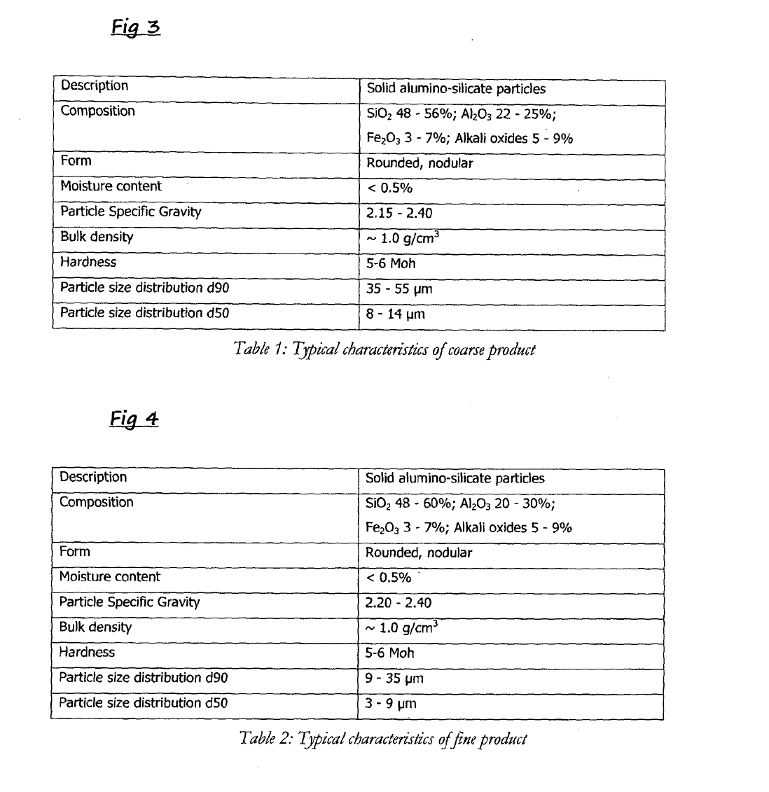

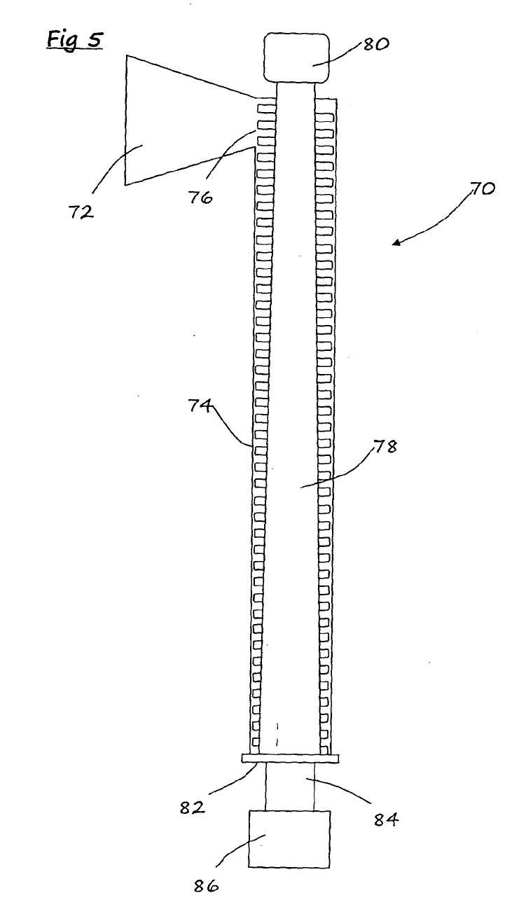

FIG. 4 is a table (Table 2) setting out the characteristics of a second particulate material formed by the method of FIG. 3;

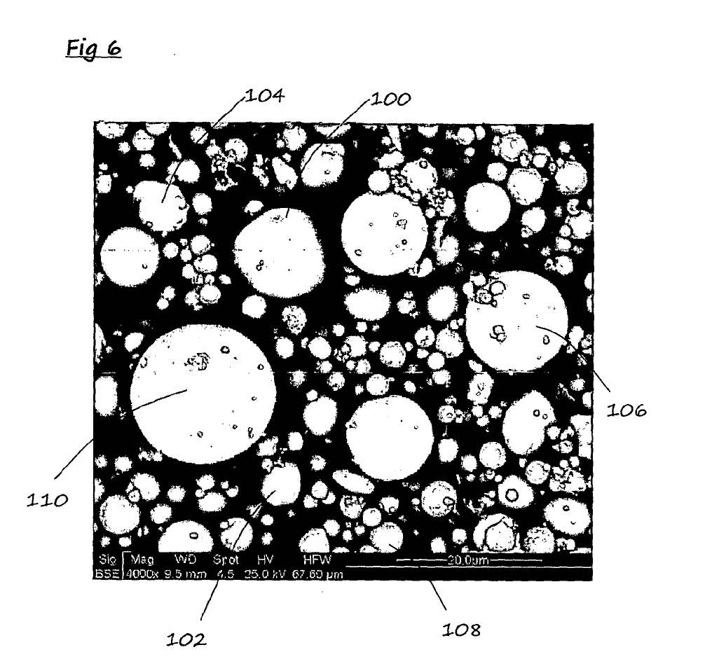

FIG. 5 illustrates an extruder for extruding synthetic plastics material compounded with a filler/extender comprising particulate material of the kind produced by the process of FIG. 2; and

FIG. 6 is an image from a scanning electron microscope (SEM) showing particulate material produced by the beneficiation method of FIG. 3.

Referring first to FIG. 1, this illustrates a power station fuelled with coal from a coal store 10. Coal from the store is delivered to a bunker 12, from which a coal feeder 14 feeds it to power plant 16 by way of a pulveriser 18. The precise form of power plant is not relevant to the present invention, but as shown in FIG. 1 the power plant 16 comprises a boiler 20 and an economiser 22, both of known form. In the power plant 16, the coal is burned to heat water and turn it into steam which is used (for instance, to power a steam turbine not shown which drives a generator not shown) to produce electricity.

Burning the coal creates various coal combustion products (CCPs), principally bottom ash and fly ash. The bottom ash from the power plant 16 is collected at A from the bottom of the boiler 20. The fly ash passes through the economiser 22 and is captured by a bank of electrostatic separators 24, from where it is accumulated at B in a stockpile or lagoon 26. The gaseous products of combustion, now cleaned of fly ash (and possibly otherwise treated) are released through the main chimney 28 of the power station.

Referring now to FIG. 2, this illustrates a process according to the invention of beneficiating the fly ash from the power station of FIG. 1. The fly ash results from iron oxides, sulphides, shale and clay minerals present in the coal burned in the power station. In the combustion process these minerals are rapidly melted, at temperatures in the range of about 1350° and 1700°, resulting in the formation of alumino-silicate particles of generally spheroidal form. The characteristics of the particles, including chemistry, morphology and particle size, vary according to the nature of the minerals present and the temperature and operating conditions of the power plant, but the particles are for the most part amorphous and vitrified because of rapid cooling of the flue gases. The fly ash is mixed with water for stockpiling as damp solid or in a lagoon.

For both environmental and commercial reasons, beneficiation as illustrated by FIG. 2 is preferred to disposal. First, fly ash accumulated (in a dewatered lagoon or in a stockpile) or obtained directly from electrostatic precipitators at a coal-fired power station such as that of FIG. 1 is reclaimed using conventional open pit mining equipment and mixed with water to form a slurry at 30.

The fly ash carries various extraneous deposits on its surface. These are mostly salts (especially alkali metal compounds) that are believed to be precipitated from condensates onto the particulate material (which is alumino-silicate) when formed in the power station furnace. We have found that these extraneous deposits cause polymer degradation when particulate material obtained by beneficiation of the fly ash is used as a filler/extender in plastics manufacturing. Therefore the present invention is directed primarily to the removal of the extraneous deposits.

At least some of the extraneous deposits are water-soluble salts, and accordingly as a first step in the beneficiation process the slurry at 30 goes forward to a stage 32 of water leaching. This removes extraneous surface deposits in the form of water-soluble salts.

The next stage 34 in the beneficiation process comprises deagglomeration. This is important in providing much improved dispersal (in resin) when particulate material obtained by the process is used as a filler/extender in plastics manufacturing.

After deagglomeration 34 the fly ash is subjected to surface scrubbing 36. This works by inter-particle attrition at high solids content and intense agitation to remove from the surfaces of the fly ash particles precipitated salts that are not water-soluble and have therefore been left by the water-leaching stage 32.

The water leaching 32, deagglomeration 34 and surface scrubbing 36 can all be done in an attrition scrubber indicated in broken lines at 38. The key requirement is maximal removal of extraneous surface deposits from the fly ash particles.

Water leaching 32, deagglomeration 34 and surface scrubbing 36 are followed by a screening step 40 whereby oversize particles (above 850 μm) bottom ash and tramp material are removed. The screening step 40 uses a vibrating screen and/or a moving cloth screen of conventional form.

This results in a first suspension that goes forward to step 42 of the beneficiation process, where cenospheres are removed. With a specific gravity of less than 1 and a density in the range 0.4 to 0.8 g/cm³ cenospheres are buoyant and therefore easily removed from the suspension by gravity separation of a conventional kind. The cenospheres are extracted as a concentrate that may be dewatered and sold as a wet filter cake, or processed further eg by drying and classifying. Cenospheres obtained by the process are of use for weight reduction in aerospace application, buoyancy in marine applications and sound insulation in building products.

The removal of cenospheres at step 42 results in a second suspension that goes forward to step 44 of the beneficiation process, where carbon is recovered. The fly ash being processed contains residual carbon in the form of unburnt coal and char, commonly characterised by measurement by Loss on Ignition (LOI) and typically comprising 8-14% of the fly ash. The residual carbon is a valuable material that can be removed from the suspension by known techniques of froth flotation or pneumatic froth flotation. Froth flotation utilises differences in hydrophobicity (which may be increased by the addition of surfactants and wetting agents) to separate out the residual carbon. Pneumatic froth flotation, which is much preferred in the present invention, is an enhancement in which froth flotation can be “tuned” for (in this case) carbon recovery by individually optimising its constituent elements of feed conditioning, bubble generation, bubble/particle contact and phase separation. The carbon material is extracted as a concentrate that may be dewatered and returned to the power station (FIG. 1) as a damp cake, for returning, or further processed for added value applications such as activated carbon.

The recovery of the residual carbon at step 44 results in a third suspension that goes forward to step 46 of the beneficiation process, where magnetic material is recovered from the flotation tailings (step 44) by magnetic separation in a conventional way. The magnetic material recovered has an iron content of about 40-45%. It may be extracted as a concentrate and dewatered for sale or it may be further processed eg by drying.

The removal of oversize particles, cenospheres, carbon and magnetic material results in a fourth suspension that is now, at stage 50, dewatered by thickening and filtration and then dried in a conventional way by means of a high efficiency drier.

After this, the dried particulate material is graded according to size. For purposes of illustration FIG. 2 shows coarse classification at 50 and fine classification at 52, but the beneficiation process of the invention can be arranged to produce a wide variety of products of different characteristics, according to customer requirements.

The coarse fraction from step 50 may be used as an added value product for use as a mineral filler/extender for use in thermoplastic, thermoset, elastomer, vinyl and coating applications, or in lightweight aggregate and filtration media. It may also be milled or ground.

The fine fraction from step 52 is also of use as a mineral filler/extender in thermoplastic, thermoset, elastomer vinyl and coating applications. Typical characteristics of the fine particulate material are set out in Table 1 (FIG. 3). The fine material may also be further classified by air classification to provide finer material of which typical characteristics are set out in Table 2 (FIG. 4).

For completeness it may be noted that the alumino-silicate product may be dewatered/dried before classification, as described above with reference to FIG. 2 but it is alternatively possible to classify the material while in slurry form and then dewater/dry the resultant products.

The particles resulting from the process of stages 30 to 50/52 may be given further treatments. For instance, the surfaces of the particles may be modified as at 56 by leaching with acid (oxalic, hydrofluoric, hydrochloric etc) to produce a dimpled effect and hence an increased surface area. Otherwise or as well a functional coating such as a surfactant may be applied to surfaces of the particles, as at 56.

All the particulate materials obtained from the classification stages 50 and 52, with or without further processing, are of use as fillers/extenders in plastics manufacturing, and should be understood that they may be mixed together in various proportions for various applications.

A notable use of the particulate materials is their compounding with thermoplastic resins. Compounding may be done by various mechanical processes, but a common two-stage method is as follows. In the first stage a batch of polymeric beads is loaded into the bowl of a simple planetary mixer, to be operated at room temperature, and a small quantity of light mineral oil is then added, The mixer is then operated for a few minutes to coat the beads with a thin coating of mineral oil is evenly over the base resin so as to make the individual beads sticky. In the second compounding stage a predetermined amount of particulate materials output from the beneficiation process of FIG. 3 are introduced into the bowl of the mixer. Then the mixer is run for a few more minutes until all the particulate material adheres to the oil on the beads, to coat them evenly and leave no free particulate material.

The so-called compound produced in the bowl, comprising a mixture of base resin, a small quantity of mineral oil and mineral filler, is of particular use in extrusion, as will now be described with reference to FIG. 5, which illustrates an extruder indicated generally at 70. Compound produced as above is transferred from the bowl of the mixer (not illustrated) to a hopper 72 of the extruder 70 and from the hopper 72 it is fed by gravity into the barrel 74 of the extruder 70 by way of a feed point 76. (It will be understood that FIG. 5 is a rotated view of the extruder 70. In practice the barrel 74 is substantially horizontal, and the hopper 72 extends upwards from the feed point 76 to an open top.)

The compound delivered through the feed point 76 is engaged by a screw 78 extending lengthwise of the barrel 72 and driven to rotate about its longitudinal axis by a drive motor 80, so that the compound is driven forwards along the barrel 74. The barrel 74 is heated to a predetermined temperature (depending on the resin) to melt the compound progressively as it is driven along the barrel 74. At the same time an outward taper of the screw 76 progressively increases the pressure on the compound.

At the forward end of the barrel the molten compound is forced by screw pressure through a screen pack 82 configured and arranged to remove any contaminants, to create a back pressure in the barrel 74 to facilitate melting and mixing and to counteract any “rotational memory” in the extruded compound.

A feed pipe 84 extending forward of the screen pack 82 delivers the molten compound to the die 86 of the extruder 70, and the die 86 shapes the extruded compound in well-known fashion, after which the profile so formed is rapidly cooled to maintain the shape imposed on it by the die 86.

Extrusion machines take many forms. They may have a single screw, a twin screw or multiple screws up to as many as twelve. Individual screws vary greatly in length, diameter and pitch, and as well as diameter changes the pitch of a screw may vary along its length. With multiple screws there are further variations, such as whether or not the screws intermesh and whether or not they co-rotate or counter-rotate. And, of course, different resins may require different features, to ensure uniform mixing and uniform melting to a specified melt temperature. (The present invention contemplates melt temperatures from as low as 70° C. to as high as 500° C.)

In relation to the present invention a preferred extruder has two or more screws and more than one feed point—say three feed points—so that progressive charges of mineral fillers can be introduced at different points. It is also preferred that—at least one location and preferably two—a vacuum source can be applied to draw off any gas entrained with the compound and any low boiling materials.

In the present invention, the preferred extruder has a die followed by a pelletising head to produce pellets of compound that can then be used in any appropriate plastics manufacturing process. (Those skilled in the art will appreciate that pellets are more convenient to use and easier to store than powdered compound or the ingredients therefore). Such an extruder can be used to produce plastics pellets directly (for further processing) without the need for previous mixing, from a compound of resin with particulate material(s) output from the beneficiation process of FIG. 3.

An important aspect of the direct production, without previous mixing, of pelletised compound by means of the invention is the form of the particulate material output from the beneficiation process. This is illustrated by the scanning electron microscope image of FIG. 6 which shows, by way of example, particulate material of the kind characterised above in Table 2.

Three features should be particularly noted in FIG. 6.

First, as is clear from FIG. 6, the particles produced by means of the present invention have a spheroidal form. Those skilled in the art will understand that this is rheologically advantageous in extrusion and similar processes.

Second, at the same time, the particles are neither perfectly round nor completely smooth: note, for example, the clearly non-spherical form of the particles 100 and 102; and note the surface nodules on particles 104 and 106 and many others. This means that the particles tumble as they progress through the extruder and thereby facilitate shear mixing. As a result compound including particulate material as shown in FIG. 6 is able to mix thoroughly over a relatively short length of the extruder, and without the complication and additional expense of prior mixing. Thus by means of the invention a given extruder can satisfactorily process compounds that contain larger concentrations of mineral filler than heretofore and are therefore cheaper. The effectiveness of the mixing also means that the invention enables the manufacture of articles having a surface finish that at least matches those available heretofore with much lower concentrations of filler.

With polypropylene, and most notably with high molecular weight fraction polypropylene, we have achieved entirely satisfactory and repeatable results in terms of both extrusion integrity and surface finish at 40% fill. We have achieved adequate results, but with a less good surface finish, at 60% fill. And our tests indicate that it will be possible in the near future to reach 80% fill. By contrast, previously known filler/extenders are limited to a loading of 10-20% in the finished product. Thus the performance of the invention can be summarised, in comparison with previously known methods of extrusion, as securing equal or better surface finish with more filler and less energy input.

The third feature of note in FIG. 6 is that the particles are spread over a controlled range of particle size: compare, for instance, particle 108 with particle 110. This spread provides a higher packing density than can be achieved with particles of substantially uniform size.

For the avoidance of doubt, it should also be understood that the SEM image of FIG. 6 has been included herein to illustrate certain characteristics of particulate material obtained from fly ash but those skilled in the art will perceive that it shows some nodules in the form of fusion-bonded extraneous surface deposits that may be removed by means of the invention.

Two other benefits of the invention may be noted from Tables 1 and 2. With a specific gravity below 2.4, the particles output from the beneficiation process of the invention are less dense than fillers commonly used heretofore, so articles incorporating them can be lighter. And with a hardness of 5-6 Moh the particles output from the beneficiation process of the invention are harder than fillers commonly used heretofore, so articles incorporating them can have a more robust finish.

Finally, it should be pointed out that the beneficiation process of the present invention provides three other important advantages in plastics manufacturing. First, the removal of soluble salts and surface cleaning of the particles during the de-agglomeration stage means that resins adhere firmly to the particles during extrusion or other plastics manufacturing processes. Second, the removal of the cenospheres makes articles incorporating the particles substantially stronger than otherwise, because the hollow cenospheres have less mechanical strength than the solid particles left after their removal and used as a filler/extender in plastics manufacturing. And third, removal of residual carbon (to a level of not more than 2%) reduces problematic adsorption, improves the overall mechanical strength of articles incorporating the particulate material of the invention, and improves the colour (brightness) of such articles.

1. A method of beneficiating fly ash to produce particulate material for use as a filler/extender in plastics manufacturing, characterised in that said method includes removal of extraneous surface deposits from surfaces of the particulate material.

2. A method of beneficiating fly ash as claimed in claim 1 characterised in that the removal of extraneous surface deposits includes leaching water-soluble salts from the surfaces of the particulate material.

3. A method of beneficiating fly ash as claimed in claim 1 characterised in that the removal of extraneous surface deposits includes attrition scrubbing of the particulate material.

4. A method of beneficiating fly ash as claimed in claim 1 characterised in that said method includes de-agglomerating the particulate material.

5. A method of beneficiating fly ash as claimed in claim 1 characterised in that said method includes selective liberation of mineral species from the particulate material.

6. A method of beneficiating fly ash as claimed in claim 1 characterised in that said method includes staged screening of the particulate material to produce particles within defined size bands.

7. A method of beneficiating fly ash as claimed in claim 1 characterised in that said method includes milling the particulate material.

8. A method of beneficiating fly ash as claimed in claim 1 characterised in that said method includes separating cenospheres from the particulate material by means of gravity separation.

9. A method of beneficiating fly ash as claimed in claim 1 characterised in that said method includes separating carbon from the particulate material by means of pneumatic froth flotation.

10. A method of beneficiating fly ash as claimed in claim 1 characterised in that said method includes separating magnetic material from the particulate material.

11. A method of beneficiating fly ash as claimed in claim 1 characterised in that surfaces of the particulate material are modified by leaching with hydrofluoric acid or hydrochloric acid or oxalic acid.

12. A method of beneficiating fly ash as claimed in claim 1 characterised in that said method comprises the steps of.
(a) forming a slurry of the fly ash;
(b) de-agglomerating particles in the slurry to produce a suspension;
(c) screening the suspension to remove therefrom particles above a specified size; and
(d) removing cenospheres, carbon and magnetic material from the suspension.

13. A filler/extender for use in plastics manufacturing, which filler comprises particulate material produced by the beneficiation of fly ash according to a method as claimed in claim 1, characterised in said particulate material comprises alumino-silicate particles of rounded form.

14. A filler/extender as claimed in claim 13 characterised in that said particles comprise 48-60% SiO₂ and 20-30% AL₂O₃.

15. A filler/extender as claimed in claim 13 characterised in that said particles are of non-uniform particle size.

16. A filler/extender as claimed in claim 13 characterised in that said particles have a specific gravity in the range 2.2 to 2.3.

17. A compound for plastics manufacturing characterised in that said compound comprises a resin and up to 60% filler/extender as claimed in claim 13.

18. A compound for plastics manufacturing as claimed in claim 17 characterised in that the particles of the filler/extender are nodular.

19. A compound for plastics manufacturing as claimed in claim 17 wherein the filler/extender has at least characteristics of particle size distribution d90 of 35-55 μm and particle size distribution d50 of 8-14 μm.

20. A compound for plastics manufacturing as claimed in claim 17 wherein the filler/extender has at least characteristics of particle size distribution d90 of 9-35 μm and particle size distribution d50 of 3-9 μm.

21. A method of making articles by plastics extrusion characterised in that said method comprises heating a compound as claimed in claim 17 to soften it and extruding the softened compound through a die, wherein the resin comprises polypropylene.

22. A method of making articles by plastics extrusion as claimed in claim 21 characterised in that said articles are pellets of said compound formed by pelletising the compound extruded through the die.
